(19) United States
(12) Patent Application Publication
(10) Pub. No.: US 2025/0232275 A1
(43) Pub. Date: Jul. 17, 2025

(54) MACHINE LEARNING FOR SELECTING FRONT-END DEVICES

(71) Applicant: Capital One Services, LLC, McLean, VA (US)

(72) Inventors: Rekha SIVAKOLUNDHU, Frisco, TX (US); Mohamed SECK, Aubrey, TX (US); Balasubramanian KIRAHAMDURAI, Richmond, VA (US); Madhuri KHADKA, Frisco, TX (US); Nathan SANTOS, Frisco, TX (US); Gayatri VISHNUBHOTLA, Plano, TX (US); Krystan R. FRANZEN, Mechanicsville, VA (US); Suraj PINDORIA, Novato, CA (US)

(21) Appl. No.: 18/413,642

(22) Filed: Jan. 16, 2024

(51) Int. Cl. G06Q 20/20

(52) U.S. Cl. CPC G06Q 20/202

(57) ABSTRACT

In some implementations, a user device may transmit, to a routing system, a request that indicates an amount. The user device may additionally transmit, to the routing system, a current location associated with the user device and account information associated with a user of the user device. The user device may receive, from the routing system, an indication of at least one relevant front-end device, based on the amount, a time associated with the request, the current location, and the account information. The user device may output a representation of the at least one relevant front-end device.

### BACKGROUND

Front-end devices, such as automated teller machines and point-of-sale terminals, may include limits on actions performed at the front-end devices (e.g., withdrawal maxima, limits based on available cash, deposit availabilities, and/or hour restrictions, among other examples). Attempting to perform an action at a front-end device that runs afoul of a limit results in wasted power and processing resources at the front-end device.

### SUMMARY

Some implementations described herein relate to a system for using machine learning to select front-end devices. The system may include one or more memories and one or more processors communicatively coupled to the one or more memories. The one or more processors may be configured to receive a plurality of maximum amounts associated with a plurality of front-end devices. The one or more processors may be configured to receive a plurality of location indicators associated with the plurality of front-end devices. The one or more processors may be configured to receive, from a user device, a request that indicates an amount and a current location. The one or more processors may be configured to receive traffic information associated with a recent time. The one or more processors may be configured to provide the amount and the current location to a machine learning model to receive an identifier associated with a selected front-end device, in the plurality of front-end devices, based on the plurality of maximum amounts, the plurality of location indicators, and the traffic information. The one or more processors may be configured to output an indication of the selected front-end device to the user device.

Some implementations described herein relate to a method of using machine learning to select front-end devices. The method may include transmitting, to a routing system and from a user device, a request that indicates an amount and a time associated with the request. The method may include transmitting, to the routing system and from the user device, a current location associated with the user device. The method may include transmitting, to the routing system and from the user device, account information associated with a user of the user device. The method may include receiving, from the routing system and at the user device, an indication of at least one relevant front-end device, based on the amount, the time associated with the request, the current location, and the account information. The method may include outputting a representation of the at least one relevant front-end device.

Some implementations described herein relate to a non-transitory computer-readable medium that stores a set of instructions for using machine learning to select front-end devices. The set of instructions, when executed by one or more processors of a device, may cause the device to transmit a request that indicates an amount. The set of instructions, when executed by one or more processors of the device, may cause the device to transmit a current location associated with the device. The set of instructions, when executed by one or more processors of the device, may cause the device to transmit account information associated with a user of the device. The set of instructions, when executed by one or more processors of the device, may cause the device to receive, in response to the request, an indication of at least one relevant front-end device, based on the amount, the current location, and the account information. The set of instructions, when executed by one or more processors of the device, may cause the device to output a representation of the at least one relevant front-end device.

### BRIEF DESCRIPTION OF THE DRAWINGS

FIGS. 1A-1E are diagrams of an example implementation relating to using machine learning for selecting front-end devices, in accordance with some embodiments of the present disclosure.

FIG. 2 is a diagram of an example user interface associated with showing a relevant front-end device, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to using machine learning for selecting front-end devices, in accordance with some embodiments of the present disclosure.

FIG. 6 is a flowchart of an example process relating to receiving indications of relevant front-end devices, in accordance with some embodiments of the present disclosure.

### DETAILED DESCRIPTION

The following detailed description of example implementations refers to the accompanying drawings. The same reference numbers in different drawings may identify the same or similar elements.

Front-end devices, such as automated teller machines (ATMs) and point-of-sale (PoS) terminals, may include limits on actions performed at the front-end devices (e.g., withdrawal maxima, limits based on available cash, deposit availabilities, and/or hour restrictions, among other examples). Sometimes, a user may attempt to perform an action at a front-end device that runs afoul of a limit. For example, the user may attempt to withdraw more than a withdrawal maximum and/or more than a supply level associated with the front-end device. As a result, the user may waste power and processing resources at the front-end device. In another example, the user may attempt to use the front-end device while the front-end device is deactivated (e.g., late at night) or when an access control terminal prevents use of the front-end device.

Additionally, selecting a closest front-end device is not always most efficient. For example, a user may waste more resources in traffic or otherwise while traveling to the closest front-end device than if the user were to have traveled to a further front-end device.

Some implementations described herein enable a machine learning model to use withdrawal maxima and/or supply levels to select a relevant front-end device. As a result, a user will conserve power and processing resources that otherwise would have been wasted at a different front-end device that is unable to complete the user's desired action. Additionally, some implementations described herein further enable the machine learning model to use traffic information to select the relevant front-end device. As a result, the user will conserve resources that otherwise would have been wasted in traffic (or otherwise) while traveling to a different front-end device.

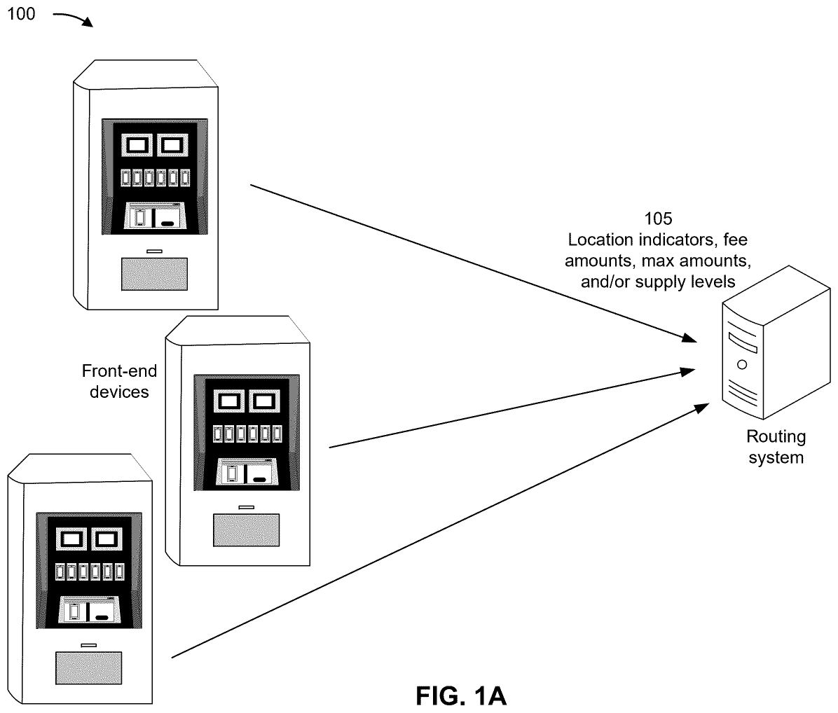

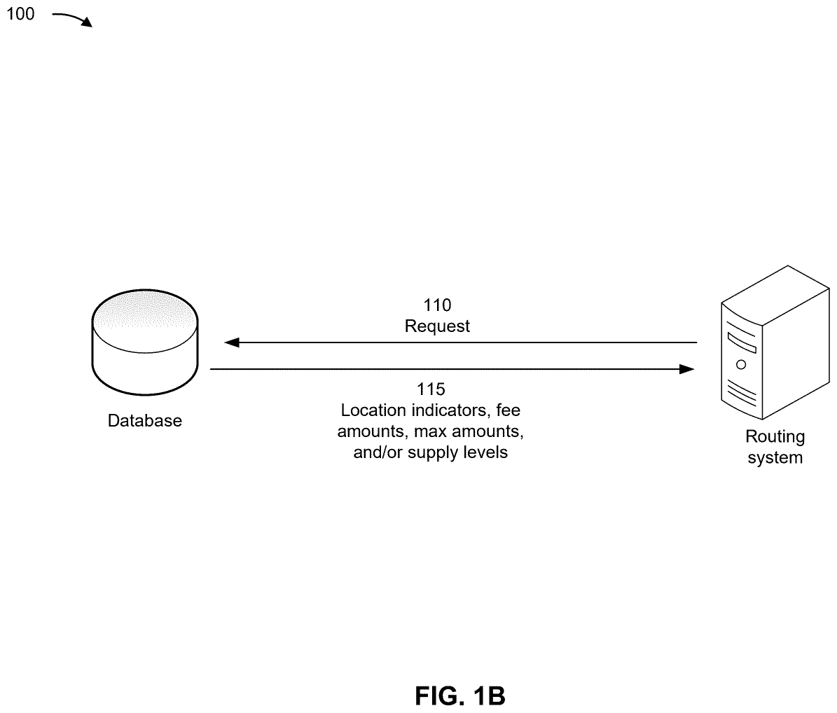

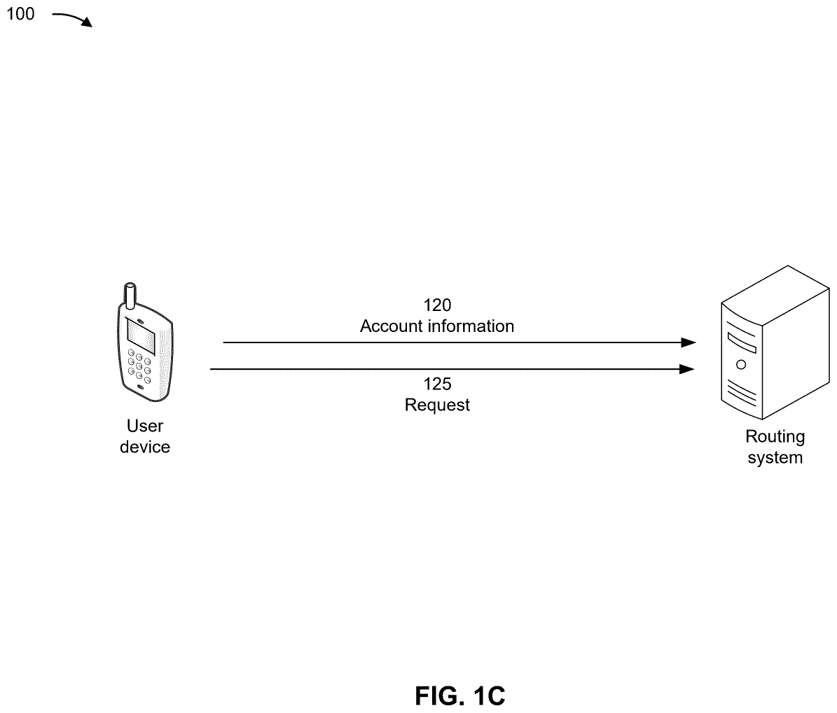

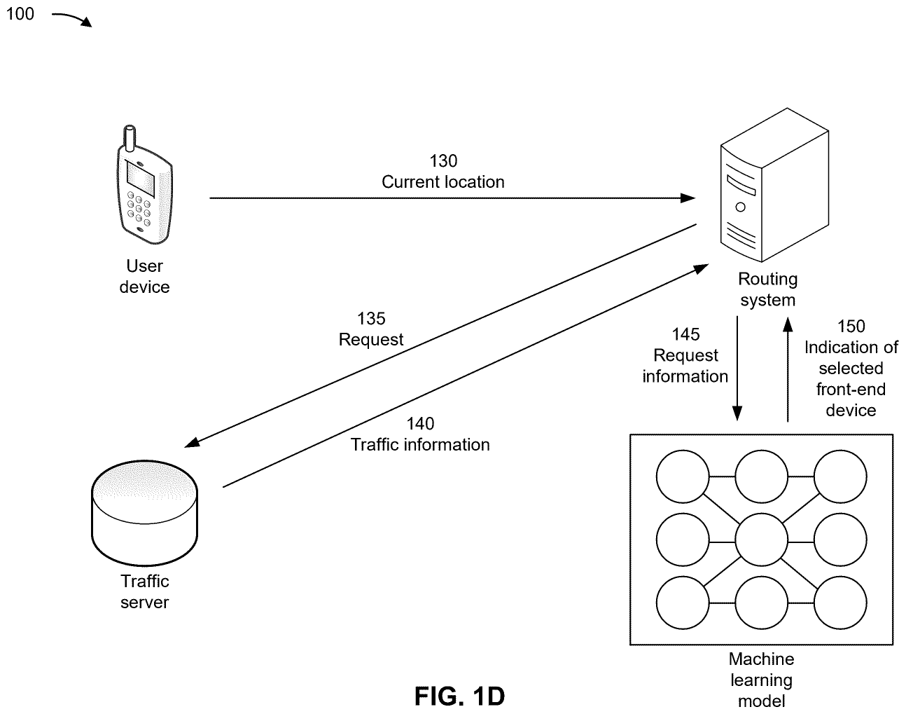

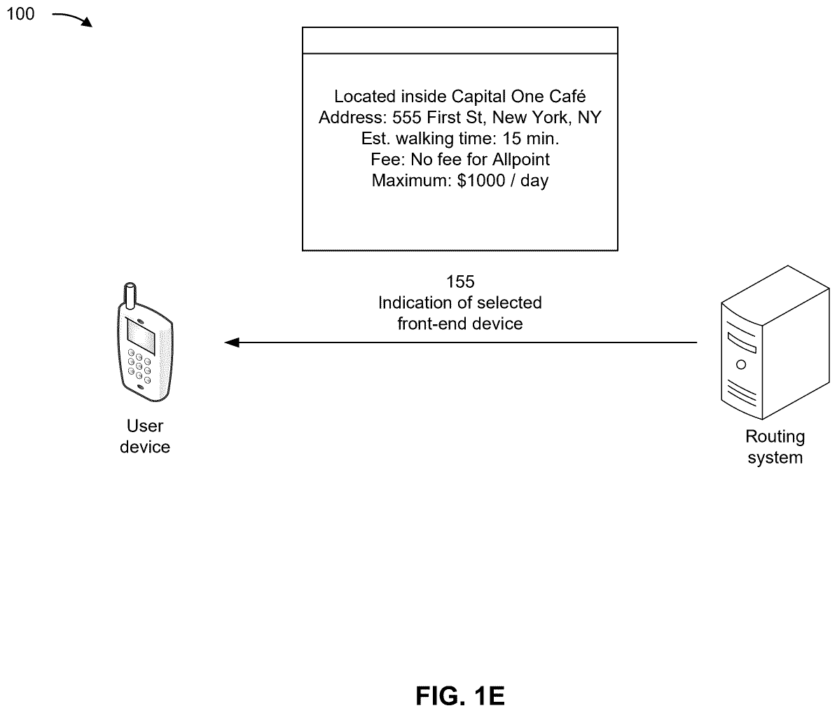

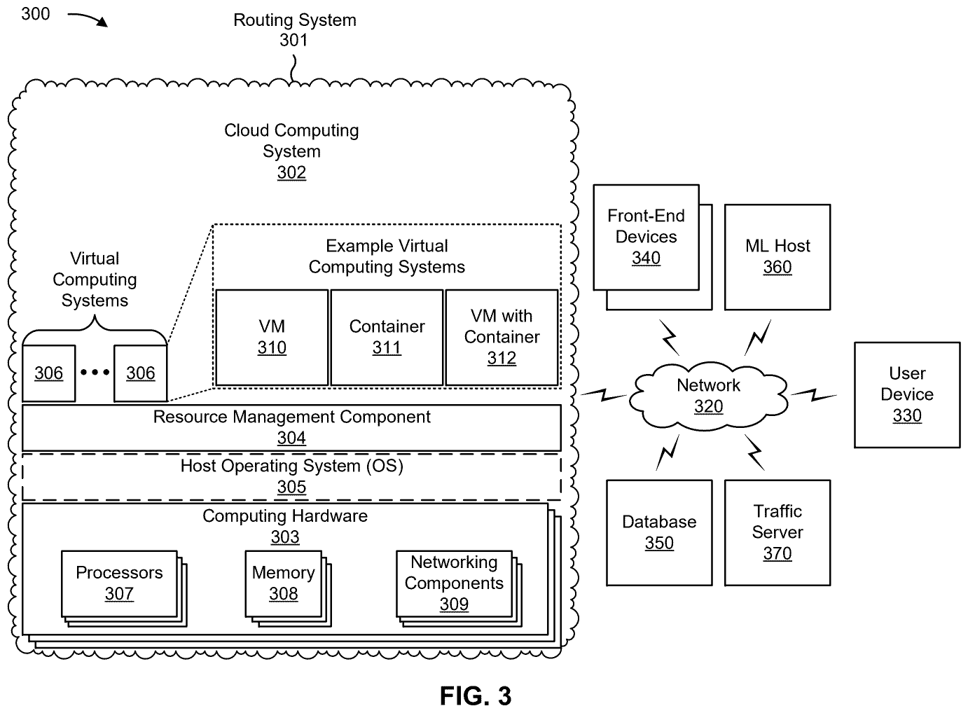

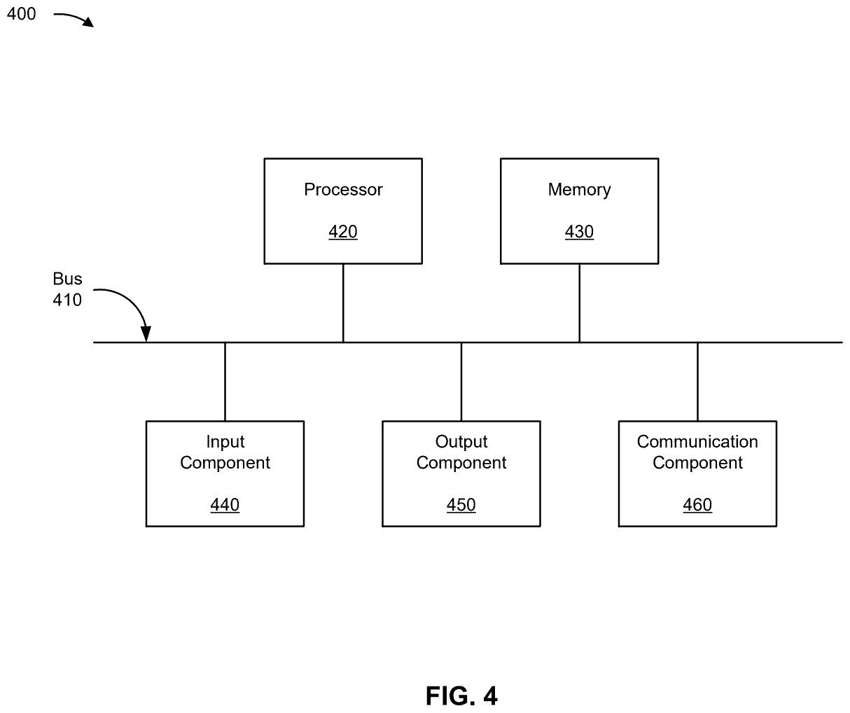

FIGS. 1A-1E are diagrams of an example 100 associated with using machine learning for selecting front-end devices. As shown in FIGS. 1A-1E, example 100 includes a plurality of front-end devices, a routing system, a database, a user device, a machine learning (ML) model (e.g., provided by an ML host), and a traffic server. These devices are described in more detail in connection with FIGS. 3 and 4.

As shown in FIG. 1A and by reference number 105, the plurality of front-end devices may transmit, and the routing system may receive, a plurality of location indicators associated with the plurality of front-end devices. Each location indicator may include a set of coordinates (e.g., using a geographic coordinate system (GCS) or another type of coordinate system) and/or an address, among other examples. In some implementations, the routing system may transmit, and each front-end device may receive, a corresponding request. Accordingly, each front-end device may transmit, and the routing system may receive, a corresponding location indicator (in the plurality of location indicators) in response to the corresponding request. Each request may include, for example, an application programming interface (API) call, and each location indicator may be received as a return from an API function. The routing system may transmit each request automatically (e.g., according to a schedule) and/or in response to input (e.g., triggering the routing system to request the plurality of location indicators).

Additionally, or alternatively, and as further shown by reference number 105, the plurality of front-end devices may transmit, and the routing system may receive, a plurality of respective fee amounts associated with the plurality of front-end devices. A respective fee amount may be a single value or may be plurality of values (e.g., associated with different ATM networks and/or different financial institutions, among other examples). In some implementations, the routing system may transmit, and each front-end device may receive, a corresponding request. Accordingly, each front-end device may transmit, and the routing system may receive, a respective fee amount (in the plurality of respective fee amounts) in response to the corresponding request. The requests for the respective fee amounts may be the same requests as used for the location indicators, as described above, or may be different requests. Each request may include, for example, an API call, and each respective fee amount may be received as a return from an API function. The routing system may transmit each request automatically (e.g., according to a schedule) and/or in response to input (e.g., triggering the routing system to request the plurality of respective fee amounts).

Additionally, or alternatively, and as further shown by reference number 105, the plurality of front-end devices may transmit, and the routing system may receive, a plurality of maximum amounts associated with the plurality of front-end devices. A maximum amount may include a per-transaction limit (e.g., no more than $500 withdrawn at once and/or no more than $500 deposited at once) and/or a per-day limit (e.g., no more than $1000 withdrawn per day and/or no more than $1000 deposited per day), among other examples. In some implementations, the routing system may transmit, and each front-end device may receive, a corresponding request. Accordingly, each front-end device may transmit, and the routing system may receive, a corresponding maximum amount (in the plurality of maximum amounts) in response to the corresponding request. The requests for the maximum amounts may be the same requests as used for the location indicators and/or the respective fee amounts, as described above, or may be different requests. Each request may include, for example, an API call, and each maximum amount may be received as a return from an API function. The routing system may transmit each request automatically (e.g., according to a schedule) and/or in response to input (e.g., triggering the routing system to request the plurality of maximum amounts).

Additionally, or alternatively, and as further shown by reference number 105, the plurality of front-end devices may transmit, and the routing system may receive, a plurality of respective supply levels associated with the plurality of front-end devices. A respective supply level may include a total level (e.g., a total of $1000 available) and/or a per-bill level (e.g., a total of one hundred $20 bills available), among other examples. In some implementations, the routing system may transmit, and each front-end device may receive, a corresponding request. Accordingly, each front-end device may transmit, and the routing system may receive, a respective supply level (in the plurality of respective supply levels) in response to the corresponding request. The requests for the respective supply levels may be the same requests as used for the location indicators, the respective fee amounts, and/or the maximum amounts, as described above, or may be different requests. Each request may include, for example, an API call, and each respective supply level may be received as a return from an API function. The routing system may transmit each request automatically (e.g., according to a schedule) and/or in response to input (e.g., triggering the routing system to request the plurality of respective supply levels).

Additionally, or alternatively, as shown in FIG. 1B, the routing system may receive the plurality of location indicators, the plurality of respective fee amounts, the plurality of maximum amounts, and/or the plurality of respective supply levels from the database. As shown by reference number 110, the routing system may transmit, and the database may receive, a request. The request may include a hypertext transfer protocol (HTTP) request, a file transfer protocol (FTP) request, and/or an API call, among other examples. In some implementations, the request is based on which information was received from the plurality of front-end devices, as described in connection with FIG. 1A. Therefore, the routing system may receive some types of information from the front-end devices directly and other types of information from the database. For example, the routing system may receive the plurality of maximum amounts and the plurality of respective supply levels from the plurality of front-end devices, and thus the routing system may determine to request the plurality of location indicators and the plurality of respective fee amounts from the database. Additionally, or alternatively, the routing system may receive information from some of the front-end devices directly and information associated with remaining front-end devices from the database. For example, the routing system may receive information from a portion of the plurality of front-end devices that are connected to the routing system (e.g., via a network), and thus the routing system may determine to request the information, associated with remaining front-end devices in the plurality of front-end devices (e.g., that are unconnected to the routing system), from the database. The routing system may transmit the request to the database automatically (e.g., according to a schedule) and/or in response to input (e.g., triggering the routing system to request information from the database).

As shown by reference number 115, the database may transmit, and the routing system may receive, the plurality of location indicators, the plurality of respective fee amounts, the plurality of maximum amounts, and/or the plurality of respective supply levels. The database may transmit, and the routing system may receive, this information in an HTTP response, an FTP response, and/or as a return from an API function, among other examples.

The routing system may therefore use the information from the plurality of front-end devices and/or the database to respond to user inquiries. As shown in FIG. 1C and by reference number 120, the user device may transmit, and the routing system may receive, account information associated with a user of the user device. In some implementations, the account information may include a set of credentials (e.g., a username and password, a passkey, a passcode, a personal identification number (PIN), a certificate, a private key, and/or biometric information, among other examples) associated with the user. Therefore, the routing system may validate the set of credentials (e.g., before allowing the user device to transmit a request, as described in connection with reference number 125).

Additionally, or alternatively, the account information may include a selection of a network (e.g., from a plurality of possible networks). For example, the plurality of possible networks may include ATM networks, such as Allpoint® or MoneyPass®. Additionally, or alternatively, the account information may include a selection of a financial institution (e.g., from a plurality of possible institutions). For example, the plurality of possible institutions may include banks, such as Capital One®. In some implementations, the user may interact with a user interface (UI) element (e.g., a drop-down list or a set of radio buttons, among other examples) to trigger the user device to transmit the account information.

As shown by reference number 125, the user device may transmit, and the routing system may receive, a request that indicates an amount. For example, the amount may represent how much the user desires to withdraw or deposit. In some implementations, the user device may transmit the request in response to input from the user (e.g., received using an input component of the user device). In one example, a web browser (or another application executed by the user device) may navigate to a website controlled by (or at least associated with) the routing system. Accordingly, the user may interact with a UI based on the website, generated by the web browser and output to the user (e.g., using an output component of the user device), in order to trigger the user device to transmit the request. The user may additionally interact with the UI (e.g., with a text box or another type of input element of the UI) to indicate the amount.

In some implementations, the user device may additionally transmit a time associated with the request. In one example, the user device may indicate the time in the request. Alternatively, the user device may transmit an indication of the time separately from the request. In some implementations, the user may interact with a UI, as described above, to indicate the time. Therefore, the routing system may determine relevant front-end devices based on a time input by the user (which may, for example, be later than a current time because the user is planning for the future). Additionally, or alternatively, the request may be timestamped (e.g., encoding a time associated with transmission of the request), and the routing system may use the timestamp as the time associated with the request. Additionally, or alternatively, the routing system may use a time of reception as the time associated with the request (e.g., in implementations where the request does not indicate a time and/or lacks a timestamp).

Therefore, the routing system may determine relevant front-end devices based on a current time. Additionally, or alternatively, the user device may additionally transmit a (distance) range associated with the request. In one example, the user device may indicate the range in the request. Alternatively, the user device may transmit an indication of the range separately from the request. The routing system may thus eliminate any front-end devices that are further (e.g., from a current location, as described in connection with reference number 130) than the range. In some implementations, the user may interact with a UI, as described above, to indicate the range. Additionally, or alternatively, the routing system may use a default value as the range.

Although the example 100 shows the request and the account information as transmitted separately, other examples may include the user device transmitting a single message including the request and the account information. Other examples may include the user device transmitting the set of credentials separately from a message that includes additional account information and the request.

As shown in FIG. 1D and by reference number 130, the user device may transmit, and the routing system may receive, a current location associated with the user device. In one example, the user device may indicate the current location in the request. Alternatively, the user device may transmit the current location separately from the request. The current location may be based on a global navigation satellite system (GNSS), such as the global positioning system (GPS). For example, the routing system may transmit a request to an operating system (OS) of the user device for the current location, and the OS may transmit the current location based on the user granting permission to share the current location. Therefore, the routing system may determine relevant front-end devices based on distance from the user device. Alternatively, the user of the user device may indicate the current location (e.g., using a text box or another type of input element of a UI output by the user device). Therefore, the routing system may determine relevant front-end devices based on distance from a location input by the user.

In some implementations, and as shown by reference number 135, the routing system may transmit, and the traffic server may receive, a request for traffic information. The request may include an HTTP request, an FTP request, and/or an API call, among other examples. In some implementations, the request may indicate (e.g., in a header and/or as an argument) the time indicated by the user device. Therefore, the traffic server may return, based on the time, either current traffic information or predicted traffic information. Alternatively, the traffic server may default to returning traffic information associated with a recent time (e.g., a current time or a recent past time, such as a time associated with a most recent update of the traffic information based on crowdsourcing).

The request may further indicate the current location and/or the plurality of location indicators. Accordingly, the traffic information may be associated with routes from the current location to the plurality of location indicators. In one example, the routing system may estimate a plurality of routes associated with the plurality of location indicators, such that the request is associated with the plurality of routes. The routing system may execute a path search algorithm to estimate the plurality of routes or may communicate with an external device (e.g., the traffic server and/or a different external device) to receive indications of the plurality of routes. The routing system may indicate the plurality of routes in the request for traffic information.

As shown by reference number 140, the traffic server may transmit, and the routing system may receive, the traffic information. For example, the traffic server may transmit, and the routing system may receive, the traffic information in response to the request from the routing system. The traffic information may include accidents, construction, and/or additional reports associated with the plurality of routes to a plurality of locations indicated by the plurality of location indicators (e.g., from the current location). Additionally, or alternatively, the traffic information may include estimated travel times based on the plurality of routes and/or current traffic conditions.

As shown by reference number 145, the routing system may provide the amount, the current location, the range, and/or the time to the ML model. For example, the routing system may transmit, and the ML host may receive, a request including the amount, the current location, the range, and/or the time. The ML model may be trained (e.g., by the ML host and/or a device at least partially separate from the ML host) using a labeled set of front-end devices (e.g., for supervised learning). Additionally, or alternatively, the ML model may be trained using an unlabeled set of front-end devices (e.g., for deep learning). The ML model may be configured to select a front-end device based on the plurality of location indicators, the plurality of respective fee amounts, the plurality of maximum amounts, and/or the plurality of respective supply levels. For example, the ML model may compare vectorized representations of front-end devices with a vectorized representation of the request from the user device in order to select the front-end device that has a vectorized representation closest to the vectorized representation of the request. Additionally, or alternatively, the ML model may be configured to generate clusters representing groups of front-end devices in order to select the front-end device from a cluster that most closely corresponds to the request from the user device.

In some implementations, the routing system may additionally provide the plurality of location indicators, the plurality of respective fee amounts, the plurality of maximum amounts, and/or the plurality of respective supply levels to the ML model. Additionally, or alternatively, the ML model may have been trained using the plurality of location indicators, the plurality of respective fee amounts, the plurality of maximum amounts, and/or the plurality of respective supply levels.

In some implementations, the ML model may include a regression algorithm (e.g., linear regression or logistic regression), which may include a regularized regression algorithm (e.g., Lasso regression, Ridge regression, or Elastic-Net regression). Additionally, or alternatively, the ML model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., information about front-end devices). For example, for a regression algorithm, a model parameter may include a regression coefficient (e.g., a weight). For a decision tree algorithm, a model parameter may include a decision tree split location, as an example.

Additionally, the ML host (and/or a device at least partially separate from the ML host) may use one or more hyperparameter sets to tune the ML model. A hyperparameter may include a structural parameter that controls execution of a machine learning algorithm by the cloud management device, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

As shown by reference number 150, the routing system may receive an identifier associated with a selected front-end device, in the plurality of front-end devices, from the ML model (e.g., from the ML host). The identifier may be a number, a name, and/or another type of alphanumeric indication of the selected front-end device. For example, each front-end device in the plurality of front-end devices may be associated with an identifier, and the ML model may indicate the identifier associated with the selected front-end device.

As shown in FIG. 1E and by reference number 155, the routing system may output an indication of the selected front-end device. For example, the routing system may transmit, and the user device may receive, the indication of the selected front-end device. In some implementations, the routing system may transmit, and the user device may receive, the indication in response to the request from the user device.

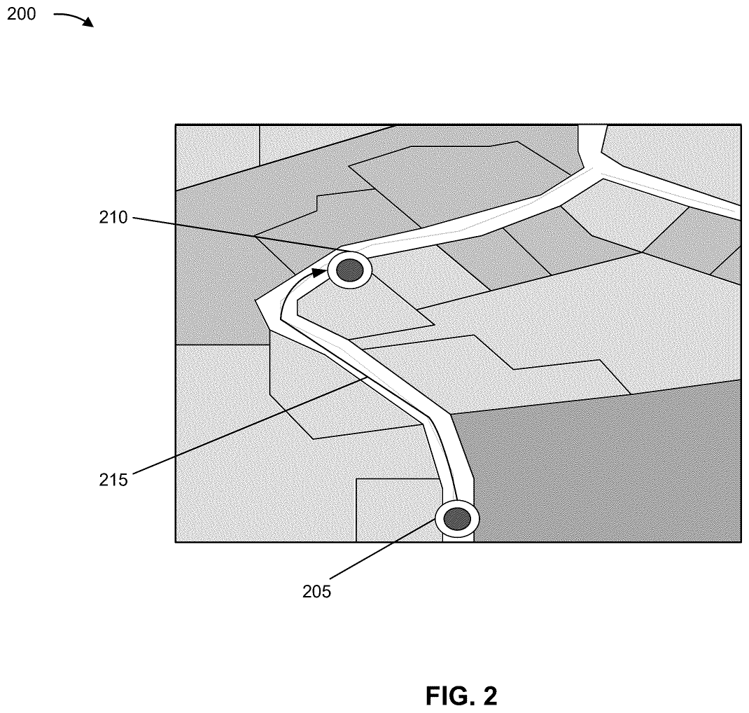

In some implementations, the routing system may transmit, and the user device may receive, instructions for a UI indicating the selected front-end device. Accordingly, the user device may output a representation of the relevant front-end device (e.g., by outputting the UI). As shown in FIG. 1E, the UI may include text indicating the location indicator associated with the selected front-end device (e.g., “Address”). The UI may further include text indicating a name associated with the selected front-end device (e.g., “Capital One Café” in FIG. 1E), the respective fee amount associated with the selected front-end device (e.g., “No fee for Allpoint” in FIG. 1E), and/or the maximum amount associated with the selected front-end device (e.g., “$1000/day” in FIG. 1E). In some implementations, the routing system may determine a route (e.g., directly or by communicating with an external device, as described above) between the current location and a location indicated by the location indicator associated with the selected front-end device. Accordingly, the UI may include text indicating the route (e.g., “Est. walking time” in FIG. 1E). Additionally, or alternatively, as described in connection with FIG. 2, the routing system may transmit, and the user device may receive and output, a map showing the current location and the location indicator associated with the selected front-end device. The map may further include an indication of the route between the current location and a location indicated by the location indicator associated with the selected front-end device, as described in connection with FIG. 2.

By using techniques as described in connection with FIGS. 1A-1E, the routing system may determine the selected front-end device using the plurality of maximum amounts and/or the plurality of respective supply levels. As a result, the user of the user device will conserve power and processing resources that otherwise would have been wasted at a different front-end device that is unable to fulfill the request (e.g., because the maximum amount is less than the amount indicated in the request and/or because the respective supply level is less than the amount indicated in the request). Additionally, the routing system may use the traffic information to determine the selected front-end device. As a result, the user of the user device will conserve resources that otherwise would have been wasted in traffic (or otherwise) while traveling to a different front-end device.

As indicated above, FIGS. 1A-1E are provided as an example. Other examples may differ from what is described with regard to FIGS. 1A-1E. Although the example 100 is described in connection with a single selected front-end device, other examples may include multiple selected front-end devices. For example, the ML model may return a list of front-end devices, and the routing system may output the list (or a portion of the list). Accordingly, in some examples, the user of the user device may indicate the selected front-end device from the list, and the representation of the selected front-end device may be output in response to the indication from the user.

FIG. 2 is a diagram of an example UI 200 associated with showing a relevant front-end device. The example UI 200 may be shown by a user device (e.g., based on instructions from a routing system). These devices are described in more detail in connection with FIGS. 3 and 4.

As shown in FIG. 2, the example UI 200 may show a current location 205 and a destination location 210 (e.g., associated with a selected front-end device, as described in connection with FIGS. 1D-1E). Additionally, as further shown in FIG. 2, the example UI 200 may show a route 215 between the current location 205 and the destination location 210.

As indicated above, FIG. 2 is provided as an example. Other examples may differ from what is described with regard to FIG. 2.

FIG. 3 is a diagram of an example environment 300 in which systems and/or methods described herein may be implemented. As shown in FIG. 3, environment 300 may include a routing system 301, which may include one or more elements of and/or may execute within a cloud computing system 302. The cloud computing system 302 may include one or more elements 303-312, as described in more detail below. As further shown in FIG. 3, environment 300 may include a network 320, a user device 330, a set of front-end devices 340, a database 350, an ML host 360, and/or a traffic server 370. Devices and/or elements of environment 300 may interconnect via wired connections and/or wireless connections.

The cloud computing system 302 may include computing hardware 303, a resource management component 304, a host OS 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the routing system 301 may include one or more elements 303-312 of the cloud computing system 302, may execute within the cloud computing system 302, and/or may be hosted within the cloud computing system 302, in some implementations, the routing system 301 may not be cloud-based (e.g., may be implemented outside of a cloud computing system) or may be partially cloud-based. For example, the routing system 301 may include one or more devices that are not part of the cloud computing system 302, such as device 400 of FIG. 4, which may include a standalone server or another type of computing device. The routing system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The user device 330 may include one or more devices capable of receiving, generating, storing, processing, and/or providing information associated with front-end devices, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 330 may communicate with one or more other devices of environment 300, as described elsewhere herein.

The set of front-end devices 340 may include one or more devices capable of facilitating an electronic transaction. For example, the set of front-end devices 340 may include a PoS terminal, a payment terminal (e.g., a credit card terminal, a contactless payment terminal, a mobile credit card reader, or a chip reader), and/or an ATM. The set of front-end devices 340 may include one or more input components and/or one or more output components to facilitate obtaining data (e.g., account information) from the user device 330 and/or to facilitate interaction with and/or authorization from an owner or accountholder of the user device 330. Example input components of the set of front-end devices 340 include a number keypad, a touchscreen, a magnetic stripe reader, a chip reader, and/or a radio frequency (RF) signal reader (e.g., a near-field communication (NFC) reader). Example output devices of the set of front-end devices 340 include a display and/or a speaker. The set of front-end devices 340 may communicate with one or more other devices of environment 300, as described elsewhere herein.

The database 350 may be implemented using one or more devices capable of receiving, generating, storing, processing, and/or providing front-end device information, as described elsewhere herein. The database 350 may be implemented using a communication device and/or a computing device. For example, the database 350 may be implemented using a server, a database server, an application server, a client server, a web server, a host server, a proxy server, a virtual server (e.g., executing on computing hardware), a server in a cloud computing system, a device that includes computing hardware used in a cloud computing environment, or a similar type of device. The database 350 may communicate with one or more other devices of environment 300, as described elsewhere herein.

The ML host 360 may include one or more devices capable of receiving, generating, storing, processing, and/or providing information associated with machine learning models, as described elsewhere herein. The ML host 360 may include a communication device and/or a computing device. For example, the ML host 360 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 360 may communicate with one or more other devices of environment 300, as described elsewhere herein.

The traffic server 370 may include one or more devices capable of receiving, generating, storing, processing, and/or providing traffic information, as described elsewhere herein. The traffic server 370 may include a communication device and/or a computing device. For example, the traffic server 370 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The traffic server 370 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with using machine learning for selecting front-end devices. The device 400 may correspond to a user device 330, a front-end device 340, a device implementing a database 350, an ML host 360, and/or a traffic server 370. In some implementations, a user device 330, a front-end device 340, a device implementing a database 350, an ML host 360, and/or a traffic server 370 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

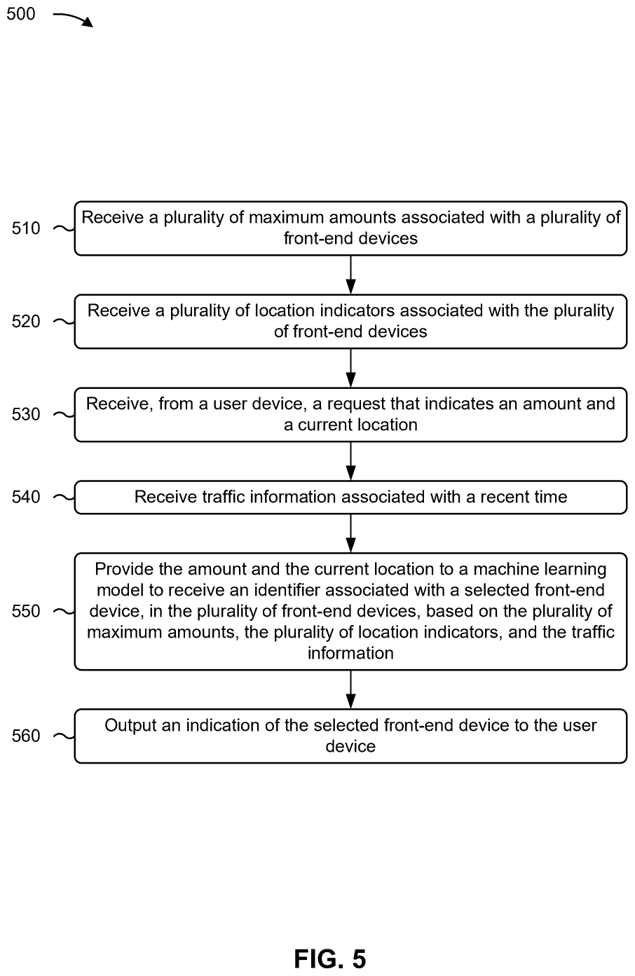

FIG. 5 is a flowchart of an example process 500 associated with using machine learning for selecting front-end devices. In some implementations, one or more process blocks of FIG. 5 may be performed by a routing system 301. In some implementations, one or more process blocks of FIG. 5 may be performed by another device or a group of devices separate from or including the routing system 301, such as a user device 330, a front-end device 340, a device implementing a database 350, an ML host 360, and/or a traffic server 370. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving a plurality of maximum amounts associated with a plurality of front-end devices (block 510). For example, the routing system 301 (e.g., using processor 420, memory 430, input component 440, and/or communication component 460) may receive a plurality of maximum amounts associated with a plurality of front-end devices, as described above in connection with reference number 105 of FIG. 1A. As an example, the routing system 301 may transmit, and each front-end device may receive, a corresponding request. Accordingly, each front-end device may transmit, and the routing system 301 may receive, a corresponding maximum amount (in the plurality of maximum amounts) in response to the corresponding request. Additionally, or alternatively, the routing system 301 may transmit, and a database may receive, a request. Accordingly, the database may transmit, and the routing system 301 may receive, the plurality of maximum amounts in response to the request.

As further shown in FIG. 5, process 500 may include receiving a plurality of location indicators associated with the plurality of front-end devices (block 520). For example, the routing system 301 (e.g., using processor 420, memory 430, input component 440, and/or communication component 460) may receive a plurality of location indicators associated with the plurality of front-end devices, as described above in connection with reference number 105 of FIG. 1A. As an example, the routing system 301 may transmit, and each front-end device may receive, a corresponding request. Accordingly, each front-end device may transmit, and the routing system 301 may receive, a corresponding location indicator (in the plurality of location indicators) in response to the corresponding request. Additionally, or alternatively, the routing system 301 may transmit, and a database may receive, a request. Accordingly, the database may transmit, and the routing system 301 may receive, the plurality of location indicators in response to the request.

As further shown in FIG. 5, process 500 may include receiving, from a user device, a request that indicates an amount and a current location (block 530). For example, the routing system 301 (e.g., using processor 420, memory 430, and/or communication component 460) may receive, from a user device, a request that indicates an amount and a current location, as described above in connection with reference number 125 of FIG. 1C. As an example, the amount may represent how much the user desires to withdraw or deposit, and the current location may be based on a GNSS or may be indicated by a user of the user device. The routing system 301 may receive a single message indicating the amount and the current location or multiple messages (e.g., one message indicating the amount and another message indicating the current location).

As further shown in FIG. 5, process 500 may include receiving traffic information associated with a recent time (block 540). For example, the routing system 301 (e.g., using processor 420, memory 430, input component 440, and/or communication component 460) may receive traffic information associated with a recent time, as described above in connection with reference number 140 of FIG. 1D. As an example, the traffic information may include accidents, construction, and/or additional reports associated with the plurality of location indicators (e.g., routes to the plurality of location indicators from the current location). Additionally, or alternatively, the traffic information may include estimated travel times (e.g., from the current location to the plurality of location indicators) based on current traffic conditions.

As further shown in FIG. 5, process 500 may include providing the amount and the current location to a machine learning model to receive an identifier associated with a selected front-end device, in the plurality of front-end devices, based on the plurality of maximum amounts, the plurality of location indicators, and the traffic information (block 550). For example, the routing system 301 (e.g., using processor 420, memory 430, and/or communication component 460) may provide the amount and the current location to a machine learning model to receive an identifier associated with a selected front-end device, in the plurality of front-end devices, based on the plurality of maximum amounts, the plurality of location indicators, and the traffic information, as described above in connection with reference numbers 145 and 150 of FIG. 1D. As an example, the machine learning model may determine the selected front-end device based on a maximum amount (in the plurality of maximum amounts), associated with the selected front-end device, satisfying the amount indicated in the request. Furthermore, the machine learning model may determine the selected front-end device based on an estimated travel time, associated with a location indicator in the plurality of location indicators, for the selected front-end device being smallest relative to the current location. Therefore, the machine learning model may select a closest (e.g., by estimated travel time) front-end device that satisfies constraints from the user device (e.g., the amount).

As further shown in FIG. 5, process 500 may include outputting an indication of the selected front-end device to the user device (block 560). For example, the routing system 301 (e.g., using processor 420, memory 430, output component 450, and/or communication component 460) may output an indication of the selected front-end device to the user device, as described above in connection with reference number 155 of FIG. 1E. As an example, the indication may include instructions for a UI indicating the selected front-end device (whether in text, as shown in FIG. 1E, and/or visually, as shown in FIG. 2).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1E and/or FIG. 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

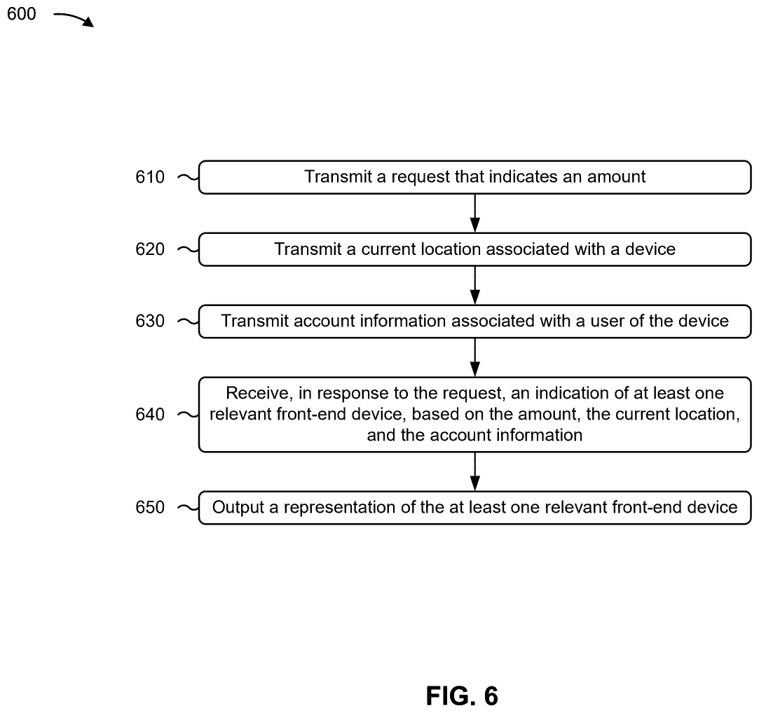

FIG. 6 is a flowchart of an example process 600 associated with receiving indications of relevant front-end devices. In some implementations, one or more process blocks of FIG. 6 may be performed by a user device 330. In some implementations, one or more process blocks of FIG. 6 may be performed by another device or a group of devices separate from or including the user device 330, such as a routing system 301, a front-end device 340, a device implementing a database 350, an ML host 360, and/or a traffic server 370. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting a request that indicates an amount (block 610). For example, the user device 330 (e.g., using processor 420, memory 430, input component 440, and/or communication component 460) may transmit a request that indicates an amount, as described above in connection with reference number 125 of FIG. 1C. As an example, a user of the user device 330 may interact with a UI (e.g., using an input component of the user device) in order to trigger the user device 330 to transmit the request. The user may additionally interact with the UI (e.g., with a text box or another type of input element of the UI) to indicate the amount.

As further shown in FIG. 6, process 600 may include transmitting a current location associated with the device (block 620). For example, the user device 330 (e.g., using processor 420, memory 430, input component 440, and/or communication component 460) may transmit a current location associated with the device, as described above in connection with reference number 130 of FIG. 1D. As an example, the current location may be based on a GNSS or may be indicated by a user of the user device 330. The user device 330 may indicate the current location in the request. Alternatively, the user device 330 may transmit the current location separately from the request.

As further shown in FIG. 6, process 600 may include transmitting account information associated with a user of the device (block 630). For example, the user device 330 (e.g., using processor 420, memory 430, input component 440, and/or communication component 460) may transmit account information associated with a user of the device, as described above in connection with reference number 120 of FIG. 1C. As an example, the account information may include a set of credentials associated with the user of the user device 330. Additionally, or alternatively, the account information may include a selection of a network (e.g., from a plurality of possible networks). Additionally, or alternatively, the account information may include a selection of a financial institution (e.g., from a plurality of possible institutions).

As further shown in FIG. 6, process 600 may include receiving, in response to the request, an indication of at least one relevant front-end device, based on the amount, the current location, and the account information (block 640). For example, the user device 330 (e.g., using processor 420, memory 430, input component 440, and/or communication component 460) may receive, in response to the request, an indication of at least one relevant front-end device, based on the amount, the current location, and the account information, as described above in connection with reference number 155 of FIG. 1E. As an example, the at least one relevant front-end device may be associated with at least one maximum amount that satisfies the amount indicated in the request. Furthermore, the at least one front-end device may be associated with smallest estimated travel times, relative to the current location, as compared with other front-end devices. Therefore, the user device 330 may receive an indication of at least one closest (e.g., by estimated travel time) front-end device that satisfies constraints from the user device 330 (e.g., the amount).

As further shown in FIG. 6, process 600 may include outputting a representation of the at least one relevant front-end device (block 650). For example, the user device 330 (e.g., using processor 420, memory 430, and/or output component 450) may output a representation of the at least one relevant front-end device, as described above in connection with FIG. 1E. As an example, the representation may include text indicating the at least one relevant front-end device (e.g., as shown in FIG. 1E). Additionally, or alternatively, the representation may visually indicate the at least one relevant front-end device (e.g., in a map, as shown in FIG. 2).

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1E and/or FIG. 2. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for using machine learning to select front-end devices, the system comprising:
one or more memories; and
one or more processors, communicatively coupled to the one or more memories, configured to:
receive a plurality of maximum amounts associated with a plurality of front-end devices;
receive a plurality of location indicators associated with the plurality of front-end devices;
receive, from a user device, a request that indicates an amount and a current location;
receive traffic information associated with a recent time;
provide the amount and the current location to a machine learning model to receive an identifier associated with a selected front-end device, in the plurality of front-end devices, based on the plurality of maximum amounts, the plurality of location indicators, and the traffic information; and
output an indication of the selected front-end device to the user device.

2. The system of claim 1, wherein the one or more processors, to receive the plurality of location indicators, are configured to:
receive at least one location indicator, in the plurality of location indicators, from at least one front-end device in the plurality of front-end devices.

3. The system of claim 1, wherein the one or more processors, to receive the plurality of location indicators, are configured to:
receive at least one location indicator, in the plurality of location indicators, from a database associated with at least one front-end device in the plurality of front-end devices.

4. The system of claim 1, wherein the one or more processors are configured to:
determine a route between the current location and a location indicated by a location indicator, in the plurality of location indicators, associated with the selected front-end device; and
output an indication of the route to the user device.

5. The system of claim 1, wherein the one or more processors, to receive the traffic information, are configured to:
estimate a plurality of routes associated with the plurality of location indicators;
transmit a request associated with the plurality of routes; and
receive the traffic information in response to the request.

6. The system of claim 1, wherein the indication of the selected front-end device comprises a map showing the current location and a location indicator, in the plurality of location indicators, associated with the selected front-end device.

7. The system of claim 1, wherein the plurality of front-end devices comprises at least one automated teller machine.

8. The system of claim 1, wherein the one or more processors are configured to:
receive a plurality of respective supply levels associated with the plurality of front-end devices,
wherein the selected front-end device is further based on the plurality of respective supply levels.

9. The system of claim 8, wherein the one or more processors, to receive the plurality of respective supply levels, are configured to:
receive at least one supply level, in the plurality of respective supply levels, from at least one front-end device in the plurality of front-end devices.

10. The system of claim 1, wherein the one or more processors are configured to:
receive a plurality of respective fee amounts associated with the plurality of front-end devices,
wherein the selected front-end device is further based on the plurality of respective fee amounts.

11. A method of using machine learning to select front-end devices, comprising:
transmitting, to a routing system and from a user device, a request that indicates an amount;
transmitting, to the routing system and from the user device, a current location associated with the user device;
transmitting, to the routing system and from the user device, account information associated with a user of the user device;
receiving, from the routing system and at the user device, an indication of at least one relevant front-end device, based on the amount, a time associated with the request, the current location, and the account information; and
outputting a representation of the at least one relevant front-end device.

12. The method of claim [symbol] , further comprising:
transmitting, to the routing system and from the user device, a set of credentials associated with the user of the user device,
wherein the request is transmitted based on the set of credentials being validated.

13. The method of claim [symbol] , wherein transmitting the account information comprises:
transmitting a selection of a network from a plurality of possible networks.

14. The method of claim [symbol] , wherein the representation comprises a map showing the current location and at least one indicator associated with the at least one relevant front-end device.

15. The method of claim [symbol] , wherein the at least one relevant front-end device comprises at least one automated teller machine.

16. A non-transitory computer-readable medium storing a set of instructions for using machine learning to select front-end devices, the set of instructions comprising:
one or more instructions that, when executed by one or more processors of a device, cause the device to:
transmit a request that indicates an amount;
transmit a current location associated with the device;
transmit account information associated with a user of the device;
receive, in response to the request, an indication of at least one relevant front-end device, based on the amount, the current location, and the account information; and
output a representation of the at least one relevant front-end device.

17. The non-transitory computer-readable medium of claim [symbol] , wherein the one or more instructions, when executed by the one or more processors, cause the device to:
transmit a range associated with the request, wherein the at least one relevant front-end device is further based on the range.

18. The non-transitory computer-readable medium of claim [symbol] , wherein the one or more instructions, that cause the device to transmit the account information, cause the device to:
transmit a selection of a financial institution from a plurality of possible institutions.

19. The non-transitory computer-readable medium of claim [symbol] , wherein the representation comprises a map showing the current location and at least one indicator associated with the at least one relevant front-end device.

20. The non-transitory computer-readable medium of claim [symbol] , wherein the at least one relevant front-end device comprises at least one automated teller machine.
